(19) United States
(12) Patent Application Publication
(10) Pub. No.: US 2021/0105387 A1
(43) Pub. Date: Apr. 8, 2021

(54) IMAGING DEVICE

(71) Applicant: NIDEC COPAL CORPORATION, Tokyo (JP)

(72) Inventors: Yuta NAKAMURA, Tokyo (JP); Takuma ISHIKAWA, Tokyo (JP)

(73) Assignee: NIDEC COPAL CORPORATION, Tokyo (JP)

(21) Appl. No.: 16/497,075

(22) PCT Filed: Mar. 26, 2018
(86) PCT No.: PCT/JP2018/012231

§ 371 Date: Sep. 24, 2019

(30) Foreign Application Priority Data
Mar. 24, 2017 (JP) 2017-060214
Mar. 24, 2017 (JP) 2017-060215

(51) Int. Cl. H04N 5/225; H04N 5/357; G03B 17/17

(52) U.S. Cl. CPC H04N 5/2254; G03B 17/17; H04N 5/3577

(57) ABSTRACT

An imaging device, having a substrate for mounting an imaging portion; a lens barrel for holding a lens group; a shield plate covering the vicinity of the substrate; and a case disposed so as to cover the lens barrel, the substrate, and the shield plate, wherein: the shield plate is structured having a contacting portion that contacts another member so as to constrain movement in the optical axial direction, and a biasing portion that contacts the coupling so as to receive a biasing force in the optical axial direction.

### CROSS-REFERENCE TO RELATED APPLICATIONS

This application is a National Stage Application of International Application No. PCT/JP2018/012231 filed Mar. 26, 2018 and claims priority to Japanese Application Nos. 2017-060214 and 2017-060215, both filed Mar. 24, 2017. All above applications are incorporated herein by reference.

### FIELD OF TECHNOLOGY

One aspect of the present invention relates to an imaging device.

### BACKGROUND

Sometimes imaging devices, wherein the lens barrel and a substrate upon which an imaging element is mounted are contained within a case, are structured through the provision of a shield plate that covers the area around the substrate on which the imaging element is mounted, as a noise countermeasure. Japanese Unexamined Patent Application Publication 2011-164461 discloses a camera device that is structured through the provision of a shield case for blocking electromagnetic radiation.

### SUMMARY OF THE INVENTION

On the other hand, in recent years vehicle-mounted cameras have become ubiquitous. In such vehicle-mounted cameras, the space for mounting is limited, and thus conventionally there have been strong demands for further miniaturization. Moreover, there have also been demands for miniaturization in imaging devices other than vehicle-mounted cameras.

The present invention adopts means such as the following in order to solve the problem described above. Note that while in the explanation below, reference symbols from the drawings are written in parentheses for ease in understanding the present invention, the individual structural elements of the present invention are not limited to those that are written, but rather should be interpreted broadly, in a range that could be understood technically by a person skilled in the art.

One means according to the present invention is an imaging device, including a substrate (41) for mounting an imaging portion; a lens barrel (3) for holding a lens group; a shield plate (6, 6a) covering the vicinity of the substrate; a case (1, 8) disposed so as to cover the lens barrel, the substrate, and the shield plate. Where the shield plate has a contacting portion (D) that contacts another member so as to prevent movement in the optical axial direction, and a biasing portion (63, 63a) that contacts another member so as to receive a biasing force in the optical axial direction.

In the imaging device of the structure set forth above, structuring through the provision of a shield plate enables isolation of electromagnetic noise in respect to the electronic components, and the like, included in the imaging portion that are mounted on the substrate, while enabling stabilization of the position of the shield plate through the biasing portion. Additionally, because the position of the shield plate is stabilized by the biasing portion, this can reduce the shape that protrudes toward the outside, when compared to a structure wherein the shield plate is secured using a pawl, or the like. This enables a structure that reduces the size of the imaging device. Moreover, when compared to a shape that uses a pawl, or the like, disassembly is easier after the device has been assembled, enabling a structure wherein repairs are easier.

In the imaging device set forth above the shield plate (6, 6a) has a flat face portion (61, 61a) that is perpendicular to the optical axial direction; and a side face portion (62, 62a) that extends from the flat face portion toward the optical axial direction, covering the outside of the substrate.

The imaging device of the structure set forth above enables effective prevention of the effects of electromagnetic noise on the substrate.

In the imaging device set forth above the biasing portion is a leaf spring portion (63, 63a) that is formed integrally with the shield plate.

Additionally, in the imaging device set forth above the biasing portion is a leaf spring portion that is formed on the flat face portion (63, 63a).

The imaging device structured as set forth above enables the position of the shield plate to be stabilized by a leaf spring that can be formed with relative ease.

In the imaging device set forth above the shield plate is connected electrically to a ground electropotential.

In the imaging device structured as set forth above, the shield plate is at the ground electropotential, enabling more effective prevention of the effects of electromagnetic noise on the substrate.

The imaging device set forth further has a connector (9, 9a), disposed in the optical axial rearward direction of the shield plate, for supplying electric power to the imaging device, wherein the shield plate is connected electrically to a ground electropotential of the connector.

In the imaging device structured as set forth above, the shield plate is connected to a low-impedance ground electropotential, enabling more effective prevention of the effects of electromagnetic noise on the substrate.

Another means according to the present invention is an imaging device, having a first substrate (41) for mounting an imaging portion; a second substrate (42) for mounting an electronic component; a lens barrel (3) for holding a lens group; a first shield plate (610) for covering the periphery of the first substrate; a second shield plate (620) for covering the periphery of the second substrate; and a case (1, 8) disposed so as to cover the lens barrel, the substrates, the first shield plate and the second shield plate, wherein: the first shield plate and the second shield plate are disposed so as to not move relative to each other in the optical axial direction; the first shield plate or the second shield plate has a contacting portion for contacting another member so as to constrain movement in the optical axial direction; and the other, of the second shield plate or the first shield plate, has a biasing portion (620c) for contacting another member so as to receive a biasing force in the optical axial direction.

In the imaging device structured as described above, the first substrate and the second substrate can be protected effectively from electromagnetic noise through the structure wherein the first shield plate and the second shield plate are provided. Moreover, the structure that has the biasing portion makes it possible to reduce the shape that protrudes toward the outside, when compared to a structure wherein the shield plates are secured using a pawl, or the like, while stabilizing the positions of the first shield plate and the second shield plate. This enables a structure that reduces the size of the imaging device. Moreover, when compared to a shape that uses a pawl, or the like, disassembly is easier after the device has been assembled, enabling a structure wherein repairs are easier.

Preferably in the imaging device set forth above the first shield plate (610) has a first flat face portion that is perpendicular to the optical axial direction; and a first side face portion that extends from the flat face portion toward the optical axial direction, covering the outside of the first substrate; and the second shield plate (620) has a second flat face portion that is perpendicular to the optical axial direction; and a second side face portion that extends from the flat face portion toward the optical axial direction, covering the outside of the second substrate.

The imaging device of the structure set forth above enables effective prevention of the effects of electromagnetic noise on the first substrate and on the second substrate.

In the imaging device set forth above the biasing portion is a leaf spring portion that is formed on the second flat face portion (620c).

The imaging device structured as set forth above enables the position of the shield plate to be stabilized by a leaf spring that can be formed with relative ease.

In the imaging device set forth above the first shield plate has the contacting portion; the second shield plate has the biasing portion; and the first flat face portion contacts an end portion, in the optical axial forward direction, of the second side face portion.

The imaging device of the structure set forth above enables a structure that can more easily stabilize the positions of the first shield plate and the second shield plate.

In the imaging device set forth above the first shield plate and the second shield plate are connected electrically to a ground electropotential.

In the imaging device structured as set forth above, the first shield plate and the second shield plate will be at the ground electropotential, enabling more effective prevention of the effects of electromagnetic noise on the substrate.

The imaging device set forth above further includes a connector (9), disposed in the optical axial rearward direction of the first shield plate and the second shield plate, for supplying electric power to the imaging device, wherein the first shield plate and the second shield plate are connected electrically to a ground electropotential of the connector.

In the imaging device structured as set forth above, the shield plate is connected to a low-impedance ground electropotential, enabling more effective prevention of the effects of electromagnetic noise on the substrates.

In the imaging device set forth above the first side face portion has a rearward extending portion (610c) that extends further in the optical axial rearward direction than the first flat face portion; and in the second side face portion, the contacting portion (620e) that contacts the first flat face portion is disposed at a position that is nearer to the optical axis than the rearward extending portion.

The imaging device structured as described above enables prevention of the second shield plate becoming detached, in the optical axial forward direction, through shifting in respect to the first shield plate.

In the imaging device set forth above the first flat face portion or the second flat face portion is disposed between the first substrate and the second substrate.

The imaging device structured as described above enables shielding of electromagnetic noise that would propagate between the first substrate and the second substrate.

### BRIEF DESCRIPTIONS OF THE DRAWINGS

FIG. 1 is an exterior perspective diagram of an imaging device according to an example, viewed from the front side.

FIG. 2 is an exterior perspective diagram of an imaging device according to an example, viewed from the rear side.

FIG. 3 is an exploded perspective diagram of an imaging device according to the an example, viewed from the front side.

FIG. 4 is an exploded perspective diagram of an imaging device according to the example, viewed from the rear side.

FIG. 5 is a cross-sectional diagram of the imaging device according to the example.

FIG. 6 is a perspective diagram of a shield plate according to the example.

FIG. 7 is a six-view diagram of a shield plate according to the example.

FIG. 8 is an exploded perspective diagram of an imaging device according to another example, viewed from the front side.

FIG. 9 is an exploded perspective diagram of an imaging device according to the other example, viewed from the rear side.

FIG. 10 is a cross-sectional diagram of the imaging device according to the other example.

FIG. 11 is a perspective diagram of a shield plate according to the other example.

FIG. 12 is a six-view diagram of a shield plate according to the other example.

FIG. 13 is an exploded perspective diagram of an imaging device according to a further example, viewed from the front side.

FIG. 14 is an exploded perspective diagram, viewing the imaging device of the further example from the front side, with the first shield plate removed.

FIG. 15 is an exploded perspective diagram of an imaging device according to the further example, viewed from the rear side.

FIG. 16 is a cross-sectional diagram of the imaging device according to the further example.

FIG. 17 is a perspective diagram of the first shield plate according to the further example.

FIG. 18 is a six-view diagram of the first shield plate according to the further example.

FIG. 19 is a perspective diagram of the second shield plate according to the further example.

FIG. 20 is a six-view diagram of the second shield plate according to the further example.

### DETAILED DESCRIPTION

In the imaging device according to the present invention, one distinctive feature is the point that the shield plate, which has a noise shielding function, has a biasing portion, and is held stably while biased in the optical axial direction.

Note that in this Specification, the position of the center of the lens, that is, the position of the center of the light that is incident into the imaging element, is termed the “optical axis.” The object that is imaged, positioned on the side of the lens that is opposite from the imaging element, will be termed the “imaging subject.” The direction in which the imaging subject is position, in respect to the imaging element, will be termed the “front side” or “optical axial forward direction,” and the direction at which the imaging element is positioned, in respect to the imaging subject, will be termed the “rear side” or “optical axial rearward direction.”

An example according to the present invention will be explained following the structures below. However, the example explained below is no more than an example of the present invention, and must not be interpreted as limiting the technical scope of the present invention. Note that in the various drawings, identical reference symbols are assigned to identical structural elements, and explanations thereof may be omitted.

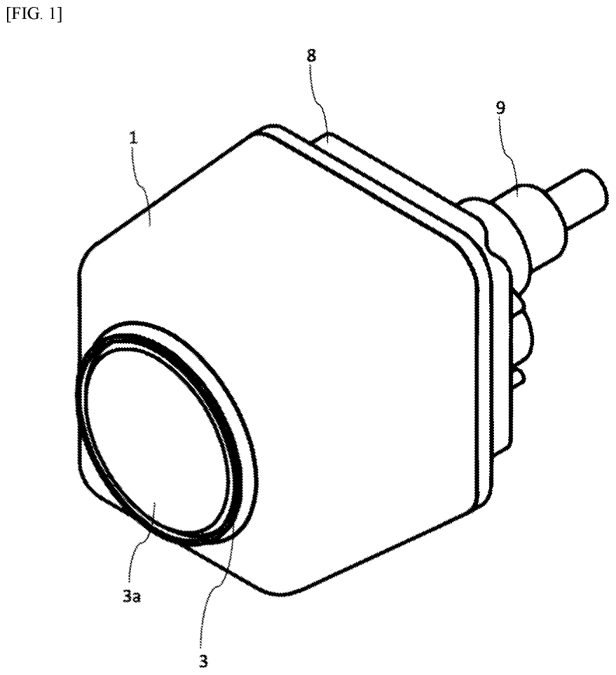

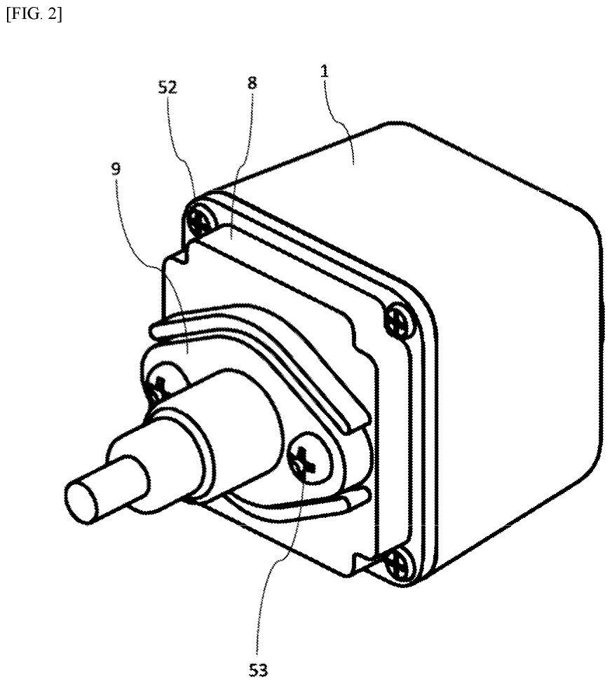

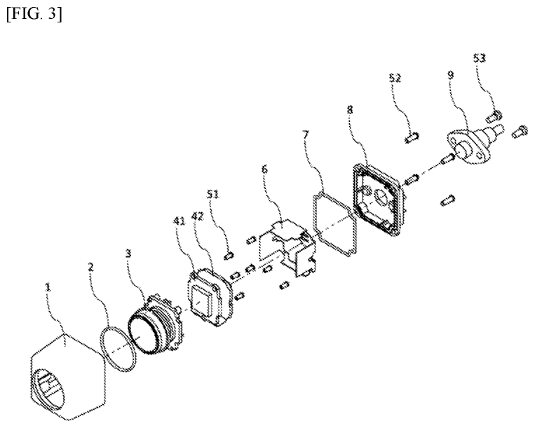

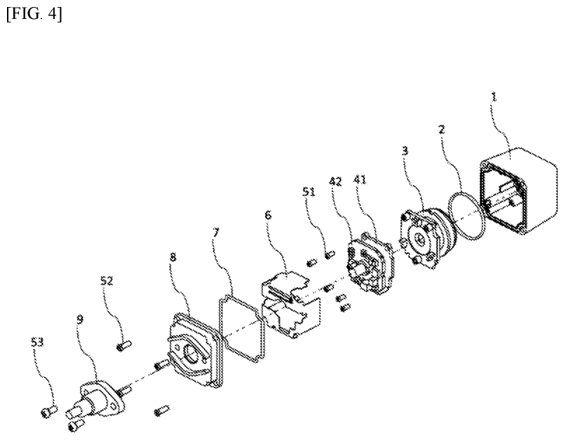

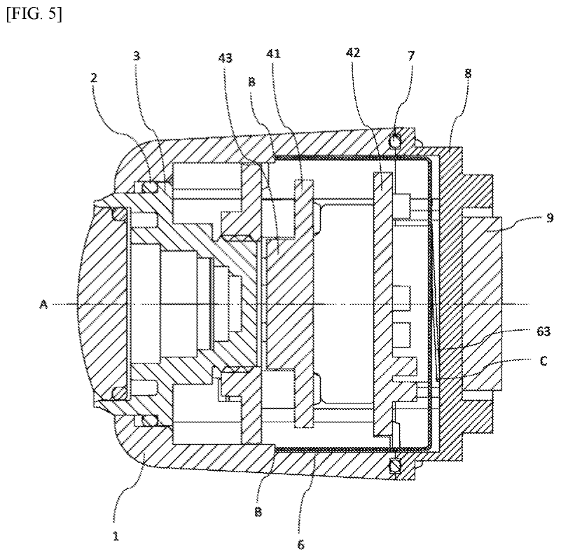

An example according to the present invention will be explained in reference to the drawings. FIG. 1 and FIG. 2 are exterior perspective diagrams of an imaging device according to the present example, wherein FIG. 1 is a diagram seen from the front side and FIG. 2 is a diagram seen from the rear side. FIG. 3 and FIG. 4 are perspective assembly diagrams of an imaging device according to the present example, wherein FIG. 3 is a diagram seen from the front side and FIG. 4 is a diagram seen from the rear side. FIG. 5 is a cross-sectional diagram of the imaging device according to the present example.

As depicted in FIG. 1 through FIG. 5, an imaging device according to the present example is structured including a front case 1, a waterproofing seal 2, a lens barrel 3, a first substrate 41, a second substrate 42, a shield plate 6, a waterproofing seal 7, a rear case 8, a connector 9, and couplings 51, 52, and 53.

<Front Case 1>

The front case 1 is a member for forming the case of the imaging device, together with the rear case 8, and is formed from resin, or the like. The front case 1 has an opening portion, centered on the optical axis A, in the optical axial forward direction, and, in the optical axial rearward direction, is open, so as to be able to connect to the rear case 8, and has side faces in essentially a rectangular shape, so as to cover the optical axis A. By connecting the front case 1 and the rear case 8, a space is formed that contains the lens barrel 3, the first substrate 41, the second substrate 42, and the like. As depicted in FIG. 1, the lens 3a, which is held by the lens barrel 3, is positioned in the opening portion in the optical axial forward direction of the front case 1.

<Rear Case 8>

The rear case 8, through connection to the front case 1, as described above, forms a space for containing the lens barrel 3, the first substrate 41, the second substrate 42, and the like. The rear case 8 is a plate-shaped member having a surface that is essentially perpendicular to the optical axis A. The rear case 8 has an opening portion in the optical axial rearward direction. A protruding portion of a connector 9 is inserted into the opening portion of the rear case 8. The rear case 8 is connected to the front case 1 through a coupling 52, and connected to the connector 9 through a coupling 53.

<Waterproofing Seal 2>

The waterproofing seal 2 is a circular ring-shaped member is formed from an elastic material such as rubber, and is disposed between the front case 1 and the lens barrel 3 to act to connect the front case 1 and the lens barrel 3 together without a gap. The waterproofing seal 2 is of a circular ring shape, along the position of the outer edge of the opening portion of the front case 1.

<Lens Barrel 3>

The lens barrel 3 is a cylindrical member that extends in the optical axial direction. The lens barrel 3 holds at least one optical member, including a lens 3a. Optical members held in the lens barrel 3 include, in addition to the lens 3a, lenses, spacers, aperture plates, optical filters, and the like. The lens that includes the lens 3a is formed from a raw material that has transparency, such as glass, plastic, or the like, and refracts and transmits, in the optical axial rearward direction, the light from the optical axial forward direction. The spacers are flat annular ring-shaped members having an appropriate thickness in the optical axial direction, to adjust the positions of the individual lenses in the optical axial direction. The spacers have opening portions in the center portions thereof, including the optical axis. The aperture plate determines the outermost position of the light that passes therethrough. The optical filters suppress or block light of prescribed wavelengths. Optical filters include, for example, infrared radiation cut filters that reduce the infrared radiation that passes therethrough. The number of these optical members can be changed arbitrarily.

<First Substrate 41 and Second Substrate 42>

The first substrate 41 and the second substrate 42 are rigid substrates on which electronic components, including the imaging element 43, are mounted. In the present example, the imaging element 43 and electronic components are mounted on the first substrate 41, and electronic components are mounted on the second substrate 42. The first substrate 41 and the second substrate 42 are connected electrically through lead wires that are installed on a flexible substrate. The electric signals acquired from the imaging element 43 are subjected to prescribed electronic processing or signal processing by the electronic components that are mounted on the first substrate 41 and the second substrate 42, and then outputted as image data to outside of the imaging device. The first substrate 41 and the second substrate 42 are secured by the coupling 51 at positions within the imaging device.

The imaging element 43 is a photoelectric converting element for converting the incident light into electric signals, and is, for example, a CMOS sensor, a CCD, or the like, although there is no limitation thereto. Moreover, in the imaging device, an imaging portion other than the imaging element 43, having an imaging function, may be used instead. The imaging element is an example of an “imaging portion” in the present invention.

<Shield Plate 6>

The shield plate 6 is formed from an electrically conductive plate-shaped member, and, in the assembled state, is disposed so as to cover the first substrate 41 and the second substrate 42.

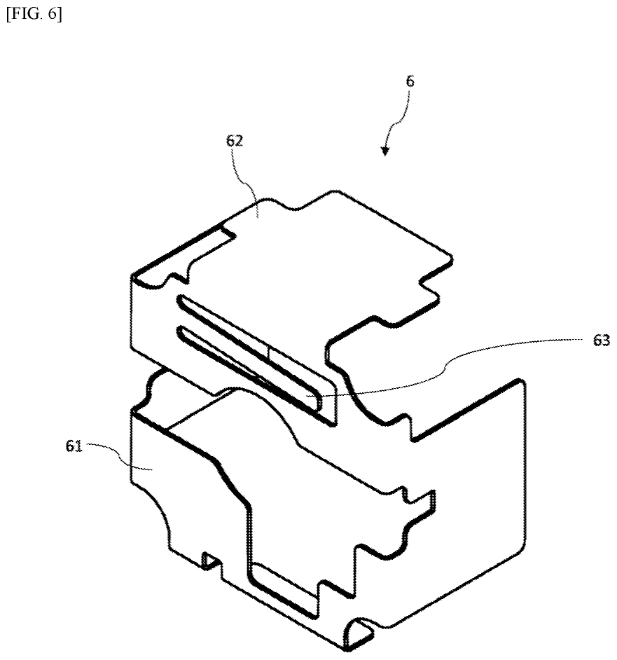

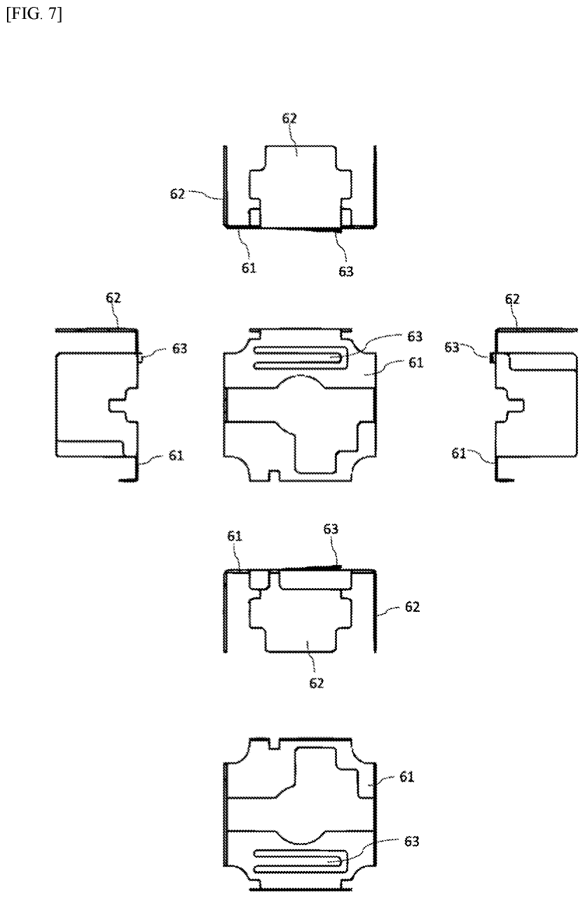

FIG. 6 is a perspective diagram of a shield plate 6 according to the present example. FIG. 7 is a six-view diagram of a shield plate 6 according to the present example. As depicted in FIG. 6 and FIG. 7, the shield plate 6 is structured including a flat face portion 61 and a side face portion 62. The flat face portion 61 is a part that is formed on a plane that is perpendicular to the optical axis A. The side face portion 62 is a part that extends from an end portion of the flat face portion 61 toward the optical axial forward direction. The side face portion 62, when viewed in a plane that is perpendicular to the optical axis A, is positioned so as to cover the first substrate 41 and the second substrate 42, from the center of the optical axis A to the outer periphery position on the outside. The flat face portion 61 is positioned so as to cover at least a portion of the first substrate 41 and the second substrate 42 in the optical axial rearward direction.

The shield plate 6 has a leaf spring portion 63, formed in the flat face portion 61. The leaf spring portion 63 is a part that is formed to protrude in the optical axial rearward direction, while having a slight angle in respect to the plane that is perpendicular to the optical axis A, through machining a portion of the plate member that forms the flat face portion 61. That is, the leaf spring portion 63 is formed integrally with the flat face portion 61. As depicted by the “C” position in FIG. 5, the leaf spring portion 63 contacts the optical axial forward direction surface of the rear case 8 elastically.

As depicted by the “B” position in FIG. 5, the optical axial forward direction end portion of the side face portion 62 of the shield plate 6 contacts the optical axial rearward direction surface of the front case 1, preventing movement in the optical axial forward direction. The end portion of the side face portion 62 in the optical axial forward direction is termed the “contacting portion.” Note that the contacting portion need only contact the position for which movement of the shield plate 6 in the optical axial forward direction is to be prevented, and may contact another structure instead of contacting the front case 1.

As described above, the contacting portion that is the optical axial forward direction end portion of the shield plate 6 contacts the surface of the front case 1, and the leaf spring portion 63, which is the optical axial rearward direction end portion of the shield plate 6, contacts the surface of the rear case 8 elastically. The position of the shield plate 6 in the optical axial direction is secured stably through biasing thereby.

<Waterproofing Seal 7>

The waterproofing seal 7 is a member that is formed from an elastic material such as rubber, as with the waterproofing seal 2, and is disposed between the front case 1 and the rear case 8, to act so as to connect the front case 1 and the rear case 8 without a gap. The waterproofing seal 7 has a shape corresponding to the connecting surface of the front case 1 and the rear case 8, where the waterproofing seal 7 in the present example is a rectangle with a corner portion cutaway.

<Connector 9>

The connector 9 is disposed to the rear of the rear case 8 in the optical axial rearward direction, and connected to the rear case 8 through a coupling 53. The connector 9, in addition to being used as the coupling for attaching the imaging device to the device to which the imaging device is to be connected, also includes signal lines, and the like, for outputting captured image data.

In the imaging device according to the present example, the shield plate 6 has a leaf spring portion 63 that functions as a biasing portion, to secure the shield plate stably through biasing. Because of this, when compared to a structure wherein the shield plate is secured using a pawl, or the like, this can reduce the shape that protrudes toward the outside, in respect to a plane that is perpendicular to the optical axis, enabling the imaging device to be structured in a smaller space. This is particularly useful when the installation space is limited, such as for an imaging device that is to be installed in a vehicle. Moreover, when compared to a shape that uses a pawl, or the like, disassembly is easier after the device has been assembled, enabling a structure wherein repairs are easier.

Moreover, in the imaging device according to the present example, the shield plate 6 has a flat face portion 61 and a side face portion 62, enabling effective prevention of incursion of electromagnetic noise from the outside to the first substrate 41 and the second substrate 42.

Moreover, in the imaging device according to the present example, a leaf spring portion 63 that is formed on the flat face portion 61 is used as the structure for securing the shield plate 6 through biasing, enabling the shield plate 6 to be secured stably through a relatively simple and inexpensive structure.

Another example according to the present invention will be explained next in reference to the drawings. When compared to the above example, the main points of difference in the present example are that the connector 9 is replaced with a coaxial connector 9a, and the shield plate 6a is connected to the ground electropotential of the coaxial connector 9a. While the present example will be explained below, explanations will be omitted for those structures and functions that are identical to those in the above example.

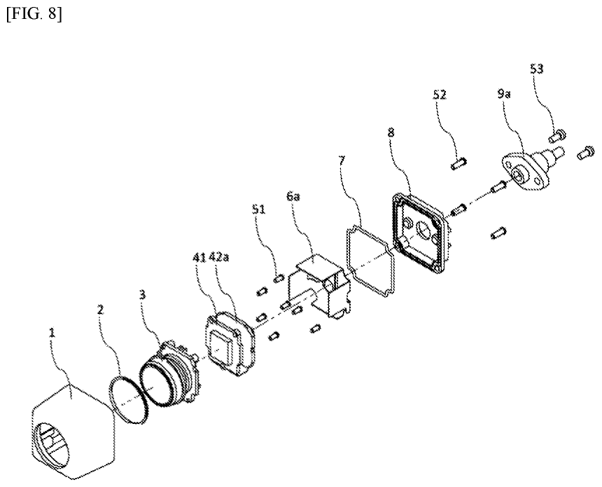

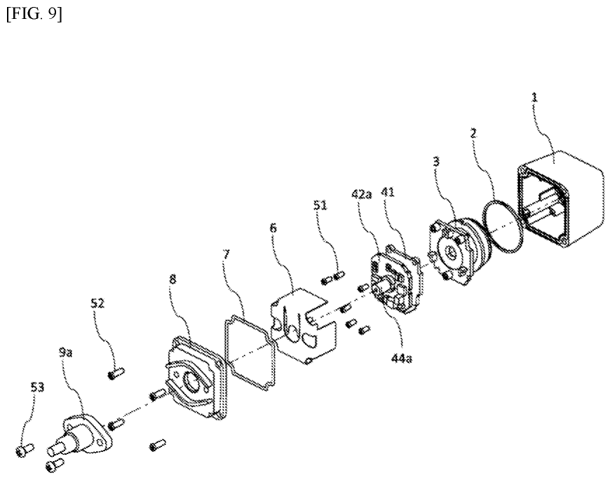

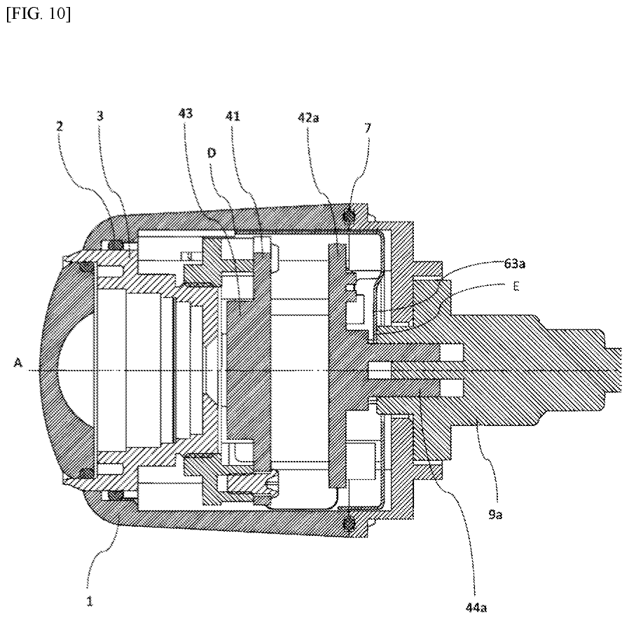

FIG. 8 and FIG. 9 are perspective assembly diagrams of an imaging device according to the present example, wherein FIG. 8 is a diagram seen from the front side and FIG. 9 is a diagram seen from the rear side. FIG. 10 is a cross-sectional diagram of the imaging device according to the present example.

As depicted in FIG. 8 through FIG. 10, an imaging device according to the present example is structured including a front case 1, a waterproofing seal 2, a lens barrel 3, a first substrate 41, a second substrate 42a, a shield plate 6a, a waterproofing seal 7, a rear case 8, a coaxial connector 9a, and couplings 51, 52, and 53.

<Shield Plate 6a>

The shield plate 6a is formed from an electrically conductive plate-shaped member, and, in the assembled state, is disposed so as to cover the first substrate 41 and the second substrate 42a. The shield plate 6a is connected electrically to the ground electropotential part of the coaxial connector 9a.

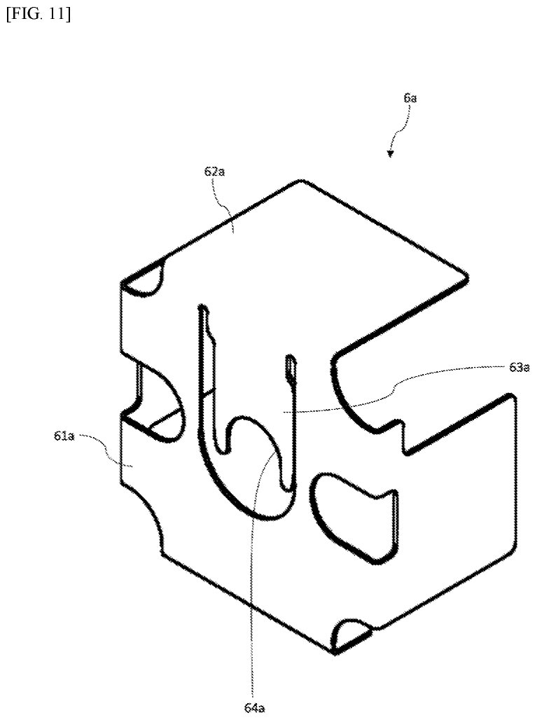

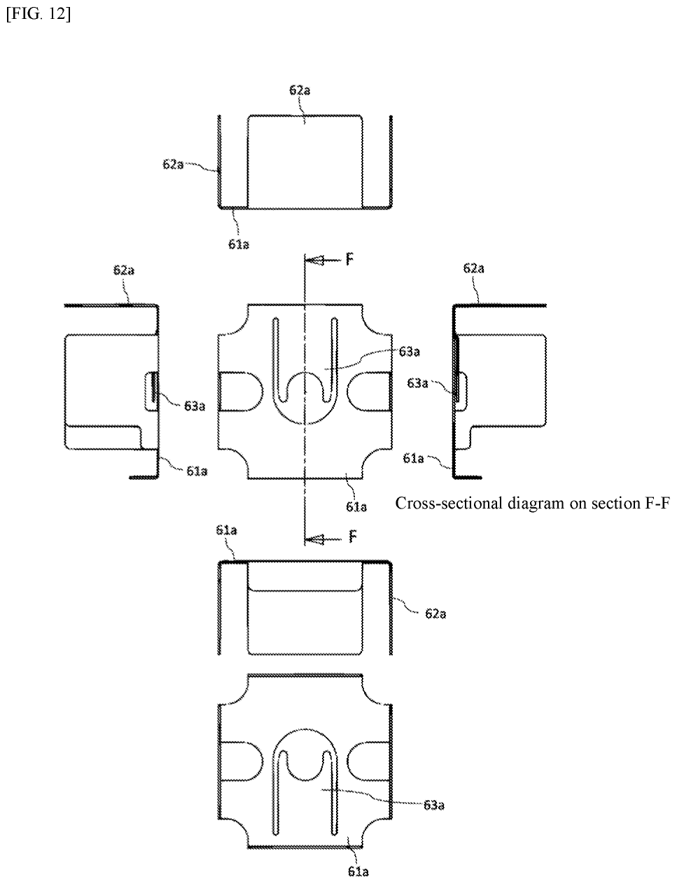

FIG. 11 is a perspective diagram of a shield plate 6a according to the present example. FIG. 12 is a six-view diagram of a shield plate 6a according to the present example. As depicted in FIG. 6 and FIG. 7, the shield plate 6a is structured including a flat face portion 61a and a side face portion 62a, the same as in the above example.

The leaf spring portion 63a is formed integrally with the flat face portion 61a. The leaf spring portion 63a has a notch portion 64a that is cut away in an arc shape. The notch portion 64a forms an arc shape along the ground electropotential part of the coaxial connector 9a, structured so as to contact the ground electropotential part with a relatively wide area (the position of “E” in FIG. 10). That is, the shield plate 6a is connected electrically to the ground electropotential of the coaxial connector 9a through the leaf spring portion 63a. In the shield plate 6a, the position is secured elastically through the leaf spring portion 63a.

As depicted by the “D” position in FIG. 10, the optical axial forward direction end portion of the side face portion 62a of the shield plate 6a contacts the optical axial rearward direction surface of the front case 1, preventing movement in the optical axial forward direction.

<Coaxial Connector 9a>

The coaxial connector 9a connects the imaging device to an external device electrically, and is also used as the attachment for attaching the imaging device to the device to which it is to be attached. The coaxial connector 9a is connected to a terminal 44a that protrudes in the optical axial rearward direction from the second substrate 42a. Moreover, the ground electropotential part of the coaxial connector 9a is contacted by the leaf spring portion 63a.

<Second Substrate 42a>

The second substrate 42a is a rigid substrate upon which electronic components are mounted, and has a terminal 44a that protrudes in the optical axial rearward direction. The terminal 44a is cylindrical, and is inserted into a hole portion that is formed in the coaxial connector 9a, to secure stably the coaxial connector 9a and the second substrate 42a.

In the imaging device according to the present example, the shield plate 6a is connected electrically to the ground electropotential through the leaf spring portion 63a. Through this, the electropotential of the shield plate 6a is stabilized as the ground electropotential, enabling more effective prevention of the effects of electromagnetic noise on the substrates. Note that the shield plate 6a need not be connected to the ground electropotential of the coaxial connector 9a, but may instead be connected to another ground electropotential.

Moreover, in the imaging device according to the present example, the shield plate 6a is connected electrically to the ground electropotential of the coaxial connector 9a, and thus the shield plate 6a is connected to a low-impedance ground electropotential, enabling more effective prevention of the effects of electromagnetic noise on the substrates.

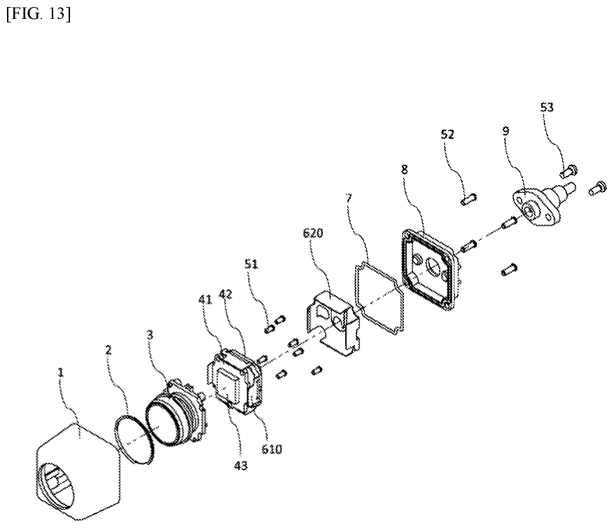

A further example according to the present invention will be explained next in reference to FIG. 1, FIG. 2, and FIG. 13 through FIG. 20. In the imaging device according to the present example, one distinctive feature is the point that two shield plates, having a noise shielding function, are provided so as to cover a first substrate and a second substrate respectively, where the shield plates have biasing portions, to be held stably, through biasing in the optical axial direction. In the present example, below, the structures and functions that are identical to those of the initial example are assigned similar reference symbols, and explanations thereof may be omitted.

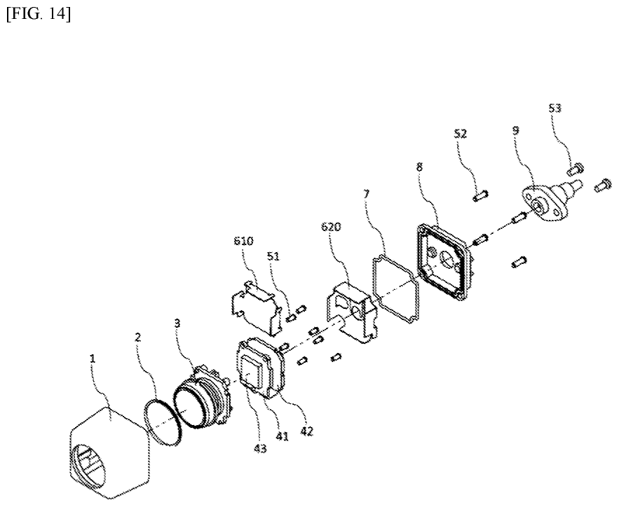

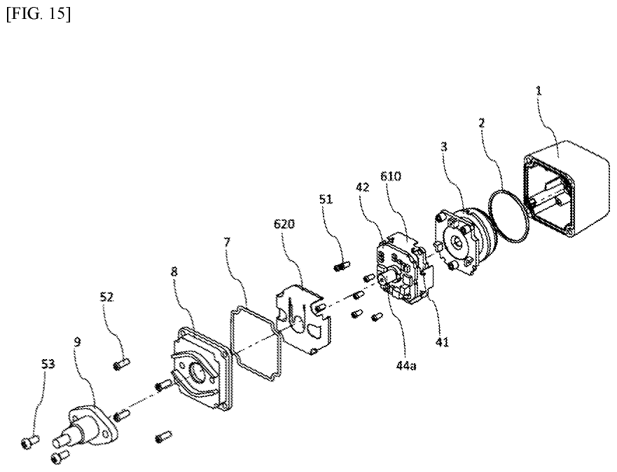

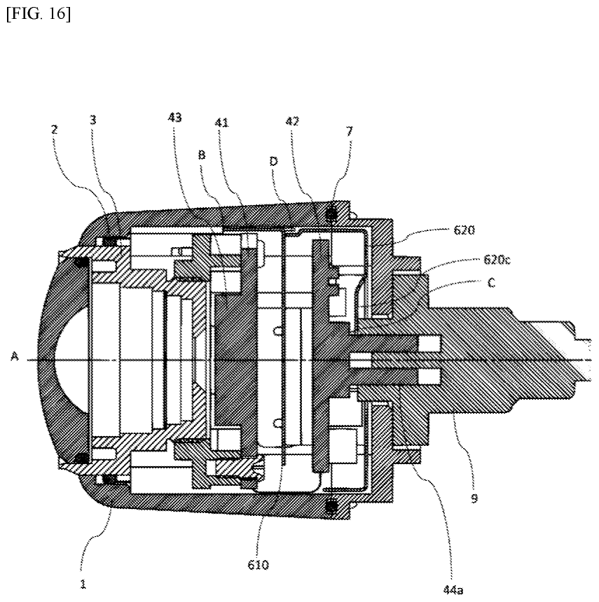

FIG. 1 and FIG. 2 are exterior perspective diagrams of an imaging device according to the present example, wherein FIG. 1 is a diagram seen from the front side and FIG. 2 is a diagram seen from the rear side. FIG. 13 through FIG. 15 are exploded perspective diagrams of imaging devices according to the present example, where FIG. 13 is a diagram looking from the front side, FIG. 14 is a diagram looking from the front side with the first shield plate removed for ease in understanding, and FIG. 15 is a diagram looking from the rear side. FIG. 16 is a cross-sectional diagram of the imaging device according to the present example.

As depicted in FIG. 1, FIG. 2, and FIG. 13 through FIG. 16, an imaging device according to the present example is structured including a front case 1, a waterproofing seal 2, a lens barrel 3, a first substrate 41, a second substrate 42, a first shield plate 610, a second shield plate 620, a waterproofing seal 7, a rear case 8, a connector 9, and couplings 51, 52, and 53.

<First Substrate 41 and Second Substrate 42>

With the first substrate 41 and the second substrate 42 according to the present example, the peripheries thereof are covered respectively by a first shield plate 610 and a second shield plate 620.

<First Shield Plate 610>

The first shield plate 610 is formed from an electrically conductive plate-shaped member, and, in the assembled state, is disposed so as to cover the first substrate 41.

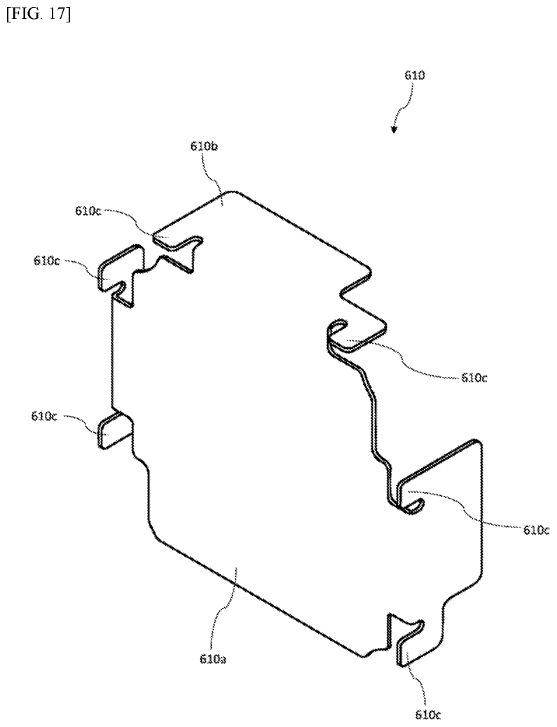

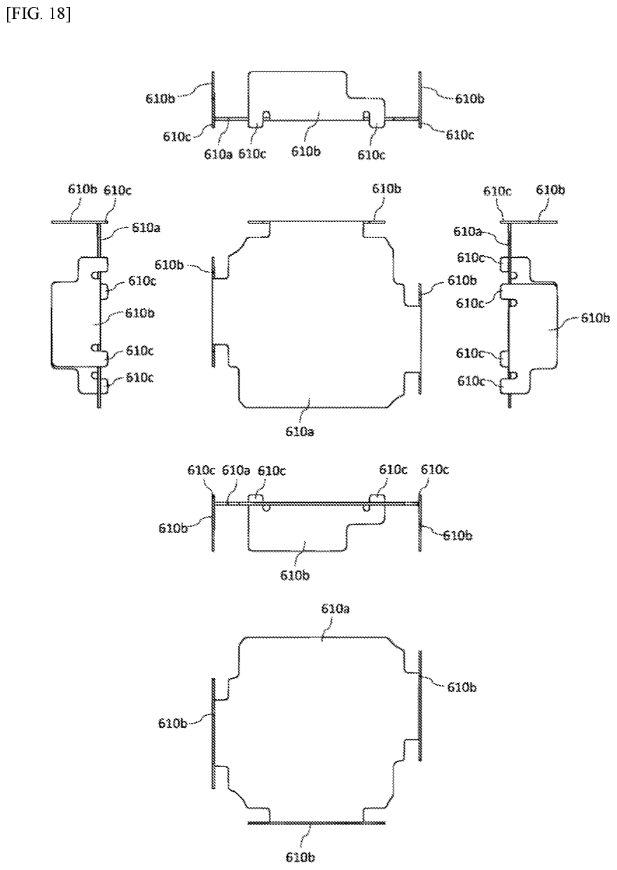

FIG. 17 is a perspective diagram of a first shield plate 610 according to the present example. FIG. 18 is a six-view diagram of the first shield plate 610 according to the present example. As depicted in FIG. 17 and FIG. 18, the first shield plate 610 is structured including a flat face portion 610a and a side face portion 610b. The flat face portion 610a is a part that is formed on a plane that is perpendicular to the optical axis A, and is positioned between the first substrate 41 and the second substrate 42. The side face portion 610b is a part that extends from three edges of the end portions of the rectangular shape of the flat face portion 610a toward the optical axial forward direction. The side face portion 610b is positioned so as to cover three directions of the rectangular part on the outside of the first substrate 41. The flat face portion 610a is positioned so as to cover at least a portion of the first substrate 41 in the optical axial rearward direction.

As depicted in FIG. 17 and FIG. 18, the side face portion 610b of the first shield plate 610 extends further in the optical axial rearward direction than the flat face portion 610a, and has a plurality of rearward extending portions 610c.

<Second Shield Plate 620>

The second shield plate 620 is formed from an electrically conductive plate-shaped member, and, in the assembled state, is disposed so as to cover the second substrate 42.

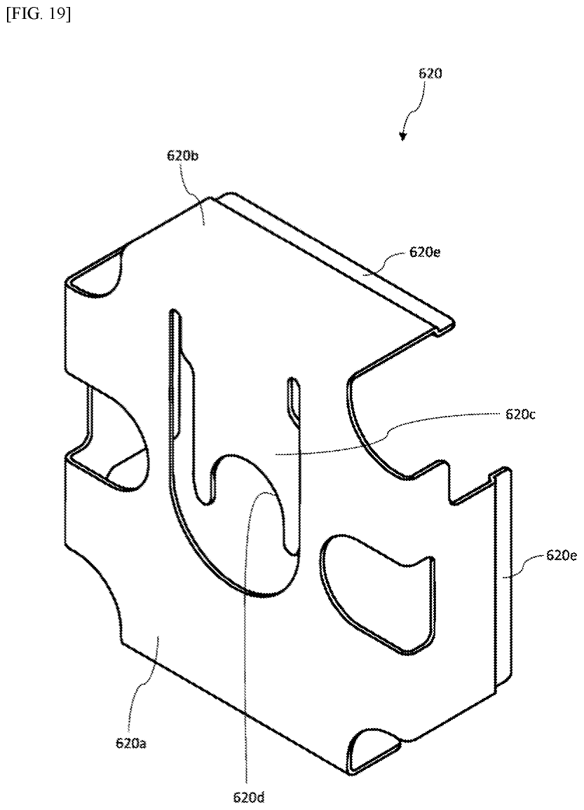

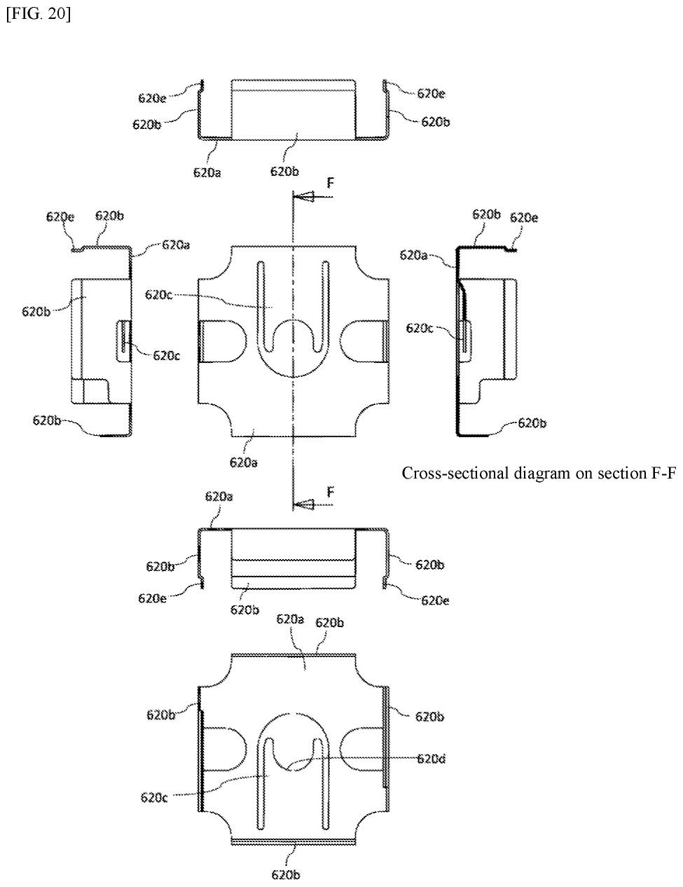

FIG. 19 is a perspective diagram of a second shield plate 620 according to the present example. FIG. 20 is a six-view diagram of the second shield plate 620 according to the present example. As depicted in FIG. 19 and FIG. 20, the second shield plate 620 is structured including a flat face portion 620a and a side face portion 620b. The flat face portion 620a is a part that is formed on a plane that is perpendicular to the optical axis A. The side face portion 620b is a part that extends from four edges of the end portions of the rectangular shape of the flat face portion 620a toward the optical axial forward direction. The side face portion 620b is positioned so as to cover the outside of the second substrate 42. The flat face portion 620a is positioned so as to cover at least a portion of the second substrate 42 in the optical axial rearward direction.

As depicted in FIG. 19 and FIG. 20, contacting portions 620e, for contacting the flat face portion 610a of the first shield plate 610, in the optical axial forward direction of the side face portion 620b of the second shield plate 620, have steps that approach the optical axis. Note that these steps in the contacting portions 620e are not absolutely necessary, but may instead be of inclined shapes, or may have shapes that have no steps nor inclines. In this way, movement of the first shield plate 610 and the second shield plate 620 relative to each other in the directions perpendicular to the optical axis is prevented by the rearward extending portions 610c of the first shield plate 610 and the contacting portions 620e of the second shield plate 620. This enables prevention of the second shield plate 620 from becoming detached, for example, in the optical axial forward direction, through shifting in respect to the first shield plate 610.

The second shield plate 620 has a leaf spring portion 620c that is formed in the flat face portion 620a. The leaf spring portion 620c is a part that is formed to protrude in the optical axial rearward direction, while having a slight angle in respect to the plane that is perpendicular to the optical axis A, through machining a portion of the plate member that forms the flat face portion 620a. That is, the leaf spring portion 620c is formed integrally with the flat face portion 620a. As depicted by the position of “C” in FIG. 16, the leaf spring portion 620c makes contact elastically with the ground electropotential part that is the optical axial forward direction surface of the connector 9.

The leaf spring portion 620c has a notch portion 620d that is cut away in an arc shape. The notch portion 620d forms an arc shape along the ground electropotential part of the coaxial connector 9, structured so as to contact the ground electropotential part with a relatively wide area (the position of “C” in FIG. 16). That is, the second shield plate 620 is connected electrically to the ground electropotential of the coaxial connector 9 through the leaf spring portion 620c. The leaf spring portion 620c is an example of a “biasing portion” in the present invention.

As depicted by the “D” position in FIG. 16, the optical axial forward direction end portion of the side face portion 620b of the second shield plate 620 contacts the flat face portion 610a of the first shield plate 610, preventing movement in the optical axial forward direction. An electrical connection is made between the second shield plate 620 and the first shield plate 610 through contact at this “D” position. Because the second shield plate 620 is connected electrically to the ground electropotential, the first shield plate 610 will also be connected electrically to the ground electropotential.

Moreover, as depicted by the position of “D” in FIG. 16, the first shield plate 610 and the second shield plate 620 have shapes that are mutually different and that fit together. Through this, the first shield plate 610 and the second shield plate 620 are connected stably, so as to not shift relative to each other. Note that the first shield plate 610 and the second shield plate 620 need not necessarily have fitting shapes such as this, but instead need only make contact so as to not move in respect to each other in the optical axial direction.

As depicted by the “B” position in FIG. 16, the optical axial forward direction end portion of the side face portion 610b of the first shield plate 610 contacts the optical axial rearward direction surface of the front case 1, preventing movement in the optical axial forward direction. This optical axial forward direction end portion of the side face portion 610b of the first shield plate 610 may be termed a “contacting portion. Note that the contacting portion need only contact the position for which movement of the first shield plate 610 in the optical axial forward direction is to be prevented, and may contact another structure instead of contacting the front case 1.

As described above, the contacting portion that is the optical axial forward direction end portion of the first shield plate 610 contacts the surface of the first case 1, and the flat face portion 610a of the optical axial rearward direction contacts the side face portion 620b of the second shield plate 620. The leaf spring portion 620c of the optical axial rearward direction of the second shield plate 620 contacts the surface of the rear case 8 elastically. The positions of the first shield plate 610 and of the second shield plate 620 in the optical axial direction are secured stably through biasing thereby.

<Connector 9>

The connector 9 is disposed to the rear of the rear case 8 in the optical axial rearward direction, and connected to the rear case 8 through a coupling 53. The connector 9 connects the imaging device to an external device electrically, and is also used as the attachment for attaching the imaging device to the device to which it is to be attached. The connector 9 is connected to a terminal 44a that protrudes in the optical axial rearward direction from the second substrate 42. Moreover, the ground electropotential part of the connector 9 is contacted by the leaf spring portion 620c.

In the imaging device according to the present example, the first substrate 41 and the second substrate 42 can be protected effectively from electromagnetic noise through the structure wherein the first shield plate 610 and the second shield plate 620 are provided. Moreover, the structure that has the leaf spring portion 620c that functions as a biasing portion makes it possible to reduce the shape that protrudes toward the outside, when compared to a structure wherein the shield plates are secured using a pawl, or the like, while stabilizing the positions of the first shield plate 610 and the second shield plate 620. This enables a structure that reduces the size of the imaging device. Moreover, when compared to a shape that uses a pawl, or the like, disassembly is easier after the device has been assembled, enabling a structure wherein repairs are easier.

Moreover, because, in the imaging device according to the present example, the first shield plate 610 and the second shield plate 620 have respective flat face portions 610a and 620a and side face portion 610b and 620b, this can more effectively prevent the effects of electromagnetic noise on the first substrate 41 and on the second substrate 42.

Additionally, in the imaging device according to the present invention, a leaf spring portion 620c, formed in the flat face portion 620a, is used as the structure for securing the second shield plate 620 through biasing. This leaf spring portion 620c enables structuring so as to secure stably, through a biasing force, the position of the first shield plate 610, in addition to the second shield plate 620.

In the imaging device according to the present invention, the first shield plate 610 has a contacting portion and the second shield plate 620 has a biasing portion, enabling the positions of the first shield plate 610 and the second shield plate 620 to be stabilized further.

Moreover, in that the imaging device according to the present example, the second shield plate 620 is connected to the ground electropotential, so both the first shield plate 610 and the second shield plate 620 will be at the ground electropotential, enabling more effective prevention of the effects of electromagnetic noise on the substrates.

Additionally, in the imaging device according to the present example, the ground electropotential part of the connector 9 is connected to the second shield plate 620 through the leaf spring portion 620c of the second shield plate 620. The second shield plate 620 and the first shield plate 610 are connected thereby to a low-impedance ground electropotential, enabling more effective prevention of the effects of electromagnetic noise on the substrates.

In the imaging device according to the present example, the flat face portion 610a of the first shield plate 610 is positioned between the first substrate 41 and the second substrate 42. This enables shielding of electromagnetic noise that would propagate between the first substrate 41 and the second substrate 42.

<4. Supplementary Items>

An example according to the present invention was explained in detail above. The explanation above is no more than an explanation of one form of example, and the scope of the present invention is not limited to this form of example, but rather is interpreted broadly, in a scope that can be understood by one skilled in the art.

For example, while in the imaging device in the example, set forth above, the shield plate 6 has a contacting portion in the optical axial forward direction and a biasing portion in the optical axial rearward direction, the structure instead may have the biasing portion in the optical axial forward direction and the contacting portion in the optical axial rearward direction. Moreover, the structure may instead have biasing portions in both the optical axial forward and rearward directions.

Moreover, the leaf spring portion 63 that is formed in the shield plate 6 need not necessarily be formed in the flat face portion 61, but rather may be formed at another location instead.

Additionally, the shield plate 6 may have another flat face portion in a position that faces the flat face portion 61 in the optical axial direction, to form a box shape. This can prevent the effects of electromagnetic noise on the first substrate 41 and the second substrate 42 more effectively.

Moreover, while in the examples the explanations used, as an example, a structure where the first substrate 41 and the second substrate 42 were structured separately, the structure need not necessarily be provided with two substrates. For example, the structure may be one that is provided with a single substrate, or a structure that is provided with three or more substrates. In this case as well, a given noise prevention effect can be produced through a structure wherein a shield plate 6 covers at least one substrate.

Moreover, there is no limitation to the front case 1 and rear case 8 being structured as in the example. For example, the shape may instead be one wherein the front case 1 is a plate-shaped member that forms a plane that is essentially perpendicular to the optical axial direction, with the rear case 8 having a plate-shaped member, formed in a plane that is essentially perpendicular to the optical axial direction, and side faces that protrude in the optical axial forward direction from the outer edge portion of the plate-shaped member. That is, the front case 1 and the rear case 8 may employ arbitrary shapes that form a case through connecting together. Moreover, the front case 1 and rear case 8 may be formed from a material other than resin.

Additionally, while the leaf spring portion 63a of the shield plate 6a had an arc-shaped notch portion 64a, the notch portion 64a need not necessarily be of an arc shape. For example, the structure may be such that the notch portion 64a has an opening portion, with an outer edge part of the opening portion is connected electrically to the ground electropotential part.

Moreover, while, in the imaging device according to the further example, described above, the first shield plate 610 had a contacting portion in the optical axial forward direction and the second shield plate 620 had a biasing portion in the optical axial rearward direction, the structure may instead be one wherein the first shield plate 610 has a biasing portion in the optical axial forward direction and the second shield plate 620 has a contacting portion in the optical axial rearward direction. Moreover, because the structure need only be such that the positions of the first shield plate 610 and of the second shield plate 620 are secured through biasing, the structure may be one wherein the first shield plate 610 and/or the second shield plate 620 has a biasing portion. The structure may be one wherein the position of contact between the first shield plate 610 and the second shield plate 620 is a biasing portion, such as a leaf spring.

Additionally, the positional relationship between the first substrate 41 and the second substrate 42 is arbitrary, and the structure may be one wherein the second substrate 42 is positioned further in the optical axial forward direction than the first substrate 41. Moreover, the structure may be one that is equipped with yet another substrate, in addition to the first substrate 41 and the second substrate 42.

Moreover, the leaf spring portion 620c that is formed in the second shield plate 620 need not necessarily be formed in the flat face portion 620a, but rather may be formed at another location instead.

Additionally, the first shield plate 610 and the second shield plate 620 may be formed into a box shape, having an additional flat face portion at a position facing the flat face portion 610a or 620a in the optical axial direction. This can prevent the effects of electromagnetic noise on the first substrate 41 and the second substrate 42 more effectively.

Additionally, while the leaf spring portion 620c of the second shield plate 620 had an arc-shaped notch portion 620d, the notch portion 620d need not necessarily be of an arc shape. For example, the structure may be such that the notch portion 620d has an opening portion, with an outer edge part of the opening portion is connected electrically to the ground electropotential part.

The present invention can be used suitably for imaging devices, or the like, for vehicle mounting.

1. An imaging device, comprising:
a substrate mounting an imaging portion;
a lens barrel holding a lens group;
a shield plate covering a periphery of the substrate; and
a case disposed so as to cover the lens barrel, the substrate, and the shield plate, wherein:
the shield plate has a contacting portion that contacts another member so as to prevent movement in the optical axial direction, and a biasing portion that contacts another member so as to receive a biasing force in the optical axial direction.

2. The imaging device as set forth in claim 1, wherein the shield plate comprises:
a flat face portion that is perpendicular to the optical axial direction; and
a side face portion that extends from the flat face portion toward the optical axial direction, covering the outside of the substrate.

3. The imaging device as set forth in claim 1, wherein the biasing portion is a leaf spring portion that is formed integrally with the shield plate.

4. The imaging device as set forth in claim 2, wherein the biasing portion is a leaf spring portion that is formed on the flat face portion.

5. The imaging device as set forth in claim 1, wherein the shield plate is connected electrically to a ground electropotential.

6. The imaging device as set forth in claim 5, further comprising:
a connector, disposed in the optical axial rearward direction of the shield plate, supplying electric power to the imaging device, wherein:
the shield plate is connected electrically to a ground electropotential of the connector.

7. An imaging device, comprising:
a first substrate mounting an imaging portion;
a second substrate mounting an electronic component;
a lens barrel holding a lens group;
a first shield plate covering a periphery of the first substrate;
a second shield plate covering a periphery of the second substrate;
a case disposed so as to cover the lens barrel, the substrates, the first shield plate and the second shield plate, wherein:
the first shield plate and the second shield plate are disposed so as to not move relative to each other in the optical axial direction;
the first shield plate or the second shield plate has a contacting portion contacting another member so as to constrain movement in the optical axial direction; and
the other, of the second shield plate or the first shield plate, has a biasing portion for contacting another member so as to receive a biasing force in the optical axial direction.

8. The imaging device as set forth in claim 7, wherein:
the first shield plate comprises:
a first flat face portion that is perpendicular to the optical axial direction; and
a first side face portion that extends from the flat face portion toward the optical axial direction, covering the outside of the first substrate; and
the second shield plate comprises:
a second flat face portion that is perpendicular to the optical axial direction; and
a second side face portion that extends from the flat face portion toward the optical axial direction, covering the outside of the second substrate.

9. The imaging device as set forth in claim 8, wherein:
the biasing portion is a leaf spring portion that is formed on the second flat face portion.

10. The imaging device as set forth in claim 7, wherein:
the first shield plate has the contacting portion;
the second shield plate has the biasing portion; and
the first flat face portion contacts an end portion, in the optical axial forward direction, of the second side face portion.

11. The imaging device as set forth in claim 7, wherein:
the first shield plate and the second shield plate are connected electrically to a ground electropotential.

12. The imaging device as set forth in claim 11, further comprising:
a connector, disposed in the optical axial rearward direction of the first shield plate and the second shield plate, for supplying electric power to the imaging device, wherein:
the first shield plate and the second shield plate are connected electrically to a ground electropotential of the connector.

13. The imaging device as set forth in claim 7, wherein:
the first side face portion has a rearward extending portion that extends further in the optical axial rearward direction than the first flat face portion; and
in the second side face portion, the contacting portion that contacts the first flat face portion is disposed at a position that is nearer to the optical axis than the rearward extending portion.

14. The imaging device as set forth in claim 7, wherein:
the first flat face portion or the second flat face portion is disposed between the first substrate and the second substrate.
